(19) United States
(12) Patent Application Publication
(10) Pub. No.: US 2015/0324336 A1
(43) Pub. Date: Nov. 12, 2015

(54) CONTENT LOCALIZATION

(71) Applicant: Transifex Limited, Camana Bay (KY)

(72) Inventors: Dimitrios Glezos, Marousi (GR); Nikolaos Vasileiou, Pallini (GR)

(73) Assignee: Transifex Limited, Camana Bay (KY)

(21) Appl. No.: 14/272,417

(22) Filed: May 7, 2014

(51) Int. Cl. G06F 17/22; G06F 17/28

(52) U.S. Cl. CPC G06F 17/2247; G06F 17/289

(57) ABSTRACT

Localization allows users from one locale to understand information originally created for users from a different locale. Localization provides users that speak a language different than the language associated with the original content to view content including text, images, videos, etc. in their own language. Localizing content may combine automatic translations, and manual localizations in order to create an aesthetically pleasing experience in a user's own language. In order to ensure the quality of localized content, systems and methods described herein disclose means by which a content owner can approve localized content before it is distributed to users. As described herein, a localization management system can provide users with quality localized content by delivering the original content along with a localization file specific to a user's own language via a content delivery network.

### TECHNICAL FIELD

The present technology pertains to the systems that aid in the localization of content, and more specifically to systems for facilitating the creation of localized content and distribution of localized content.

### BACKGROUND

Localization is the adaptation of content to a specific country, region or group. Localization typically involves an in-depth knowledge of the target culture in order to correctly adapt content (e.g., language, text, software, graphics and other content) to cultural preferences. Localization can be performed for regions or countries where people speak different languages, or regions where the same language is spoken. For example, different dialects of Spanish, with different idioms, are spoken in mainland Spain than those spoken in other parts of Spain or Latin America. Likewise, word choices and idioms vary among countries where English is the predominant language (e.g., in the United States, the United Kingdom, and the Philippines).

In addition to adapting text, localization is also related to the cultural adaptation and translation of software, video games, websites (mobile or otherwise, including elements on those websites such as graphics and widgets), mobile applications, etc. There is a need for businesses of all sizes to globalize their products with a more precise means than automated translation.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer readable storage media for performing localization. Localization, refers to the adaptation of a product for a specific market.

Localization can be performed in various ways. For example, a company that creates video games or web-content may have employees able to translate text, graphics, buttons, or other portions of content. In another example, a company may outsource the localization of content to a localization company, also referred to as Multi-Language Vendor or Single-Language Vendor. As another example, localization may be crowed sourced (e.g., the localization process is completed by receiving localized content from a variety of sources and/or users). Regardless of the process by which localization is performed, embodiments discussed herein may employ any, or a combination of, the aforementioned methods to localize content.

As described herein, content received by a computing device may be rendered in a first language. The content may include code that, when executed, determines a language preference. If the language preference is the same as the first language, the content is displayed. However, if the language preference corresponds to a different, second language, a localization file is downloaded by the computing device and elements of the content are replaced with elements in the second language (e.g., text, images, videos).

The language preference may be associated with the computing device. In some embodiments, a language preference may be determined based on the language settings of a mobile phone or the settings of a mobile application which simulates a browser. For example, the language settings on mobile phones may be chosen by a user within a settings section. In some embodiments the language preference may be determined from a subdomain associated with a website. For example, a language preference may be determined based on a URL such as de.example.com, example.com/?lang=de, or www.example.de. Moreover, in some embodiments, a website may allow a user to select a localization preference. For example, via a drop-down menu. In some embodiments, while one localization preference may be detected by the executing code via a variety of methods, a user may override the localization preference.

In some embodiments, content owners have the ability to approve localized versions of their content before an end user is able to download it. For example, a content owner may: (1) load their content into a localization management system (e.g., software as a service using an iframe which emulates code to localize their content) that allows the content owner to localize their content into a second language and view the resulting localized version; or (2) add code to their content (e.g., a web page or mobile application) such that the content owner can edit or localize the content without loading their content onto a third party server. In either case, in some embodiments, the localization management system creates a localized file with the localized content. This localized file may then be uploaded to a content delivery network, which a script is capable of accessing to replace elements in the original content. The content owner may then choose to edit the localized version of their content, and/or approve the localized version of their content. As described herein, any edits made are applied to the localization file, while the content remains in its original version. Once approved, the content and the localization file(s) are sent to a content delivery network for a client computing device to access.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example electronic environment in which methods and systems discussed herein can be executed, in accordance with various embodiments;

FIGS. 2A-2B illustrate an exemplary embodiment of a localization interface that allows a user to localize content;

FIG. 3 illustrates an exemplary embodiment of a user interface to manage localization;

FIGS. 4A-4B illustrate an exemplary method embodiment of localizing content;

FIG. 5 illustrates an exemplary method embodiment of localizing content; and

FIG. 6 illustrates an exemplary method embodiment of localizing content; and

FIGS. 7A-7B illustrate exemplary electronic environments, in accordance with various embodiments.

### DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure.

Methods and systems described herein allow a user to submit content for localization, receive localized content, approve the localized content if acceptable, edit the localized content if needed, and allow users to access the localized content by retrieving the content and a localized file generated by a localization management system from a content delivery network or other source. It should be appreciated that the content for localization may also be submitted by a browser or other source, in addition to a user. For example, a user may visit a website and see a page created by a second user. A JavaScript code may automatically detect the strings in the website (or a page therein) and send those strings to a localization management system without any user interaction. A user may never see the strings in a first language. In some embodiments, stings sent to a localization management system may enter a queue, or other structure. As discussed herein, a second user (e.g., an administrator), is capable of approving or rejecting strings submitted to the localization management system, such that they may be translated. In some embodiments, strings sent to a localization management system may be rejected because they were not meant to be uploaded (e.g., in the case of a variable). In some embodiments, a localization system may allow a user to automatically accept every string it receives rather than require a manual approval.

As used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software. In some embodiments, an action performed by a user may include accessing a web page.

Content, as described herein, may comprise a myriad of formats. For example, content may include a web site, a web page, website elements, graphics, code, html, text files, games, mobile content, user interfaces, audio, video, etc. Localization management systems are able to adapt content to a particular localization preference. With localization management systems described herein, new content appropriate for the localization preference may be created and replace the original content, such that it does not appear out of place in a localized page. In some embodiments, the localized content, may be included in a localization file to be sent in conjunction with the original content. Once at a client device, the localization file may contain content in a form appropriate for a given localization preference. That form may include various languages, additional content, or less content. For example, content may be removed from a localized webpage when translated to a particular language. In addition, content may be placed in a different location within a website or web page, appear in a different color. As should be apparent, in some embodiments images may be replaced with other images, videos may be replaced with other videos, etc.

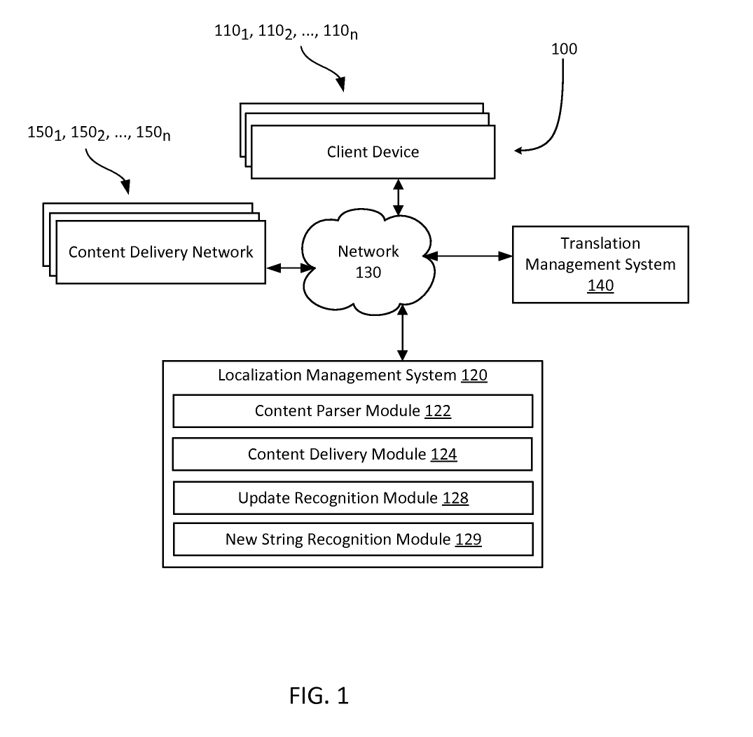

FIG. 1 illustrates an example electronic environment 100 in which methods and systems discussed herein can be executed. Example electronic environment 100 includes client devices 110₁, 110₂, . . . , 110ₙ (collectively “110”). Client devices 110 may be used to access localization management system 120 and/or content delivery system 150₁, 150₂, . . . , 150ₙ (collectively “150”) via network 130. In some examples, localization management system 120 shown in example electronic environment 100 includes example components configured to localize digital content in accordance with methods and systems addressed herein.

In some embodiments, localization management system 120 includes a content parser module 124, a content delivery module 124, and an update recognition module 128. As will be discussed in more detail below, in some embodiments a content parser module is configured to parse content (e.g., web elements, strings, phrases, images, etc.). A content delivery module 124 may deliver parsed content to a translation management system 140. An update recognition module 128 may assist with identifying and/or modifying new or modified content. In some embodiments a new string recognition module 129 may recognize strings that one or more browsers have sent to a localization management system 120. As such, localization management system 120 will not waste resources detecting a string multiple times, and various browsers will receive previously localized content.

In some embodiments, localization management system 120 receives multiple types of content to be modified. The content may be a web page configured for a particular locale (e.g., region, country, location, etc.) rendered by a browser executing on a client device. The particular locale may be associated with a particular language, dialect, or other property associated with that locale. For example, users at the particular locale may typically read text from right to left, as opposed to left to right. It is further contemplated that in some embodiments of the systems described herein, content may be modified based at least in part on information indicating a gender associated with a user, a user's ethnicity, age, country of origin, demographic, etc.

In some embodiments, a control panel provided by the location management system allows a user to localize content using a translation management system 140. An example translation management system 140 may translate elements of content in a variety of methods as discussed above. For example, a translation management system 140 may automatically translate some or all content, it may send the content to a third party that manually localizes some or all content, or the translation management system 140 may translate a portion of content automatically while sending another portion of content to be translated manually. In any case, once the translation management system 140 localizes content, it sends the localized content back to the localization management system 120. In some embodiments, a type of translation management system is selected automatically based at least in part on the cost of the localization services to be performed.

Once the localization system receives content localized and/or translated into a second language, the localization system creates a localization file to be stored in a content delivery system with the original content in a first language. When the content is returned to localization management system 120 from a translation management system, a user may verify that the localization was performed correctly. The returned content may, in some embodiments, be stored in a data structure such as a queue. Once there, a user may approve returned content to be included in the localized content. For example, when a user creates a web site which is then parsed into elements that are localized by a translation management system 140, the user will be given the opportunity to view and/or modify the localized elements before a localization file is created.

In addition to static content, a localization system may be configured to recognize dynamic content. For example, a webpage that allows users to post comments may automatically send information to a localization management system indicating that a comment has been posted, and that it should be localized. Again, in such an example the newly created content may be localized automatically, or a notification may be generated prompting a user with access to the localization management system to approve the modified localized elements. In some embodiments, the newly localized content requires approval prior to creating a modified localization file for distribution.

In some embodiments, the localization system may deliver localization files (e.g., via the content deliver module 124) to a content delivery network 150 for distribution in conjunction with the original content.

In some embodiments, a script is embedded within a web page. The script may be embedded in a webpage at the location management system 120. The script includes instructions that cause the web page to be rendered by a browser in rendered on the client device 110 in a particular manner. As described herein, the script may detect a localization preference of a particular user. The script can instruct the client device 110 to request a localization file from a network device (e.g., a server or a content delivery network 150). Upon receiving the localization file from the content delivery network, the script can interpret the localization file and render a localized version of the webpage. In some embodiments, if a particular web page or content does not have an associated localization file available, the content will be sent to a localization management system in order to localize the content.

In response to the request for a localized web page from a content delivery network 150, the content delivery network 150 may send a localization file to the client device 110, such that elements in the original content in a first language are replaced with elements in a second language. In some embodiments, the script may cause the replacement to happen in response to a user action, such as selecting a language from a drop-down menu. In some embodiments, the script may cause the replacement to occur in near-real time, such that a user never sees the original content elements before they are replaced with content elements provided by a localization file.

In some embodiments, a localized version of the file, or a portion of a file might not be available. In such embodiments, a request for localization may automatically cause a localization management system 120 to parse content and send the content (or elements therein) to a translation management system. In some embodiments, a request for localization from a client device may cause a localization management system to generate a notification indicating that a client device has requested localization of content.

It should be understood that although the localization management system 120 shown in example electronic system 100 stands alone, it may be included as part of another system. For example, localization system 120 may be included as a tool within a content management system.

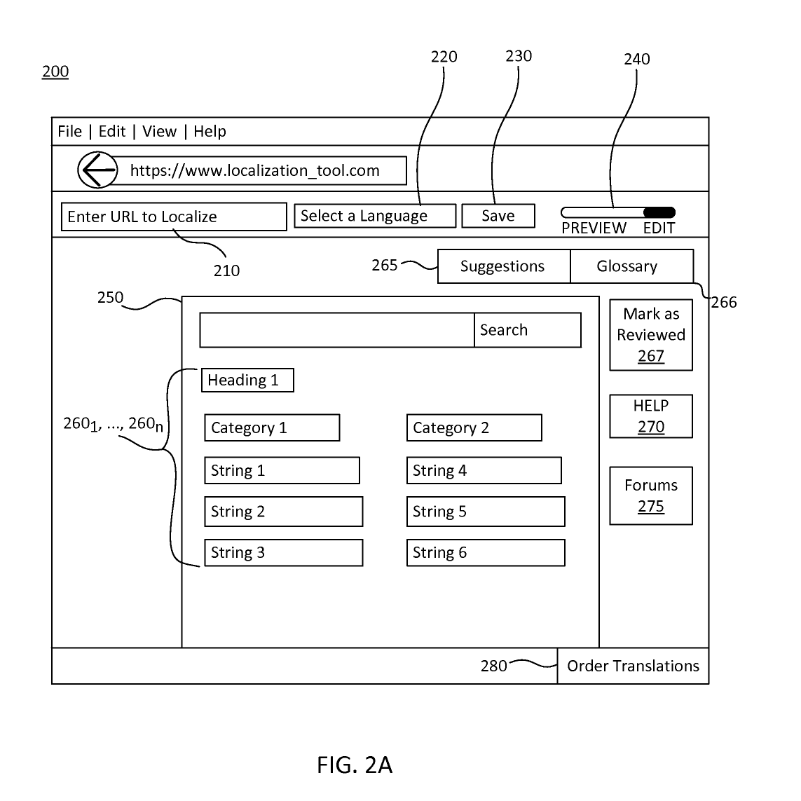

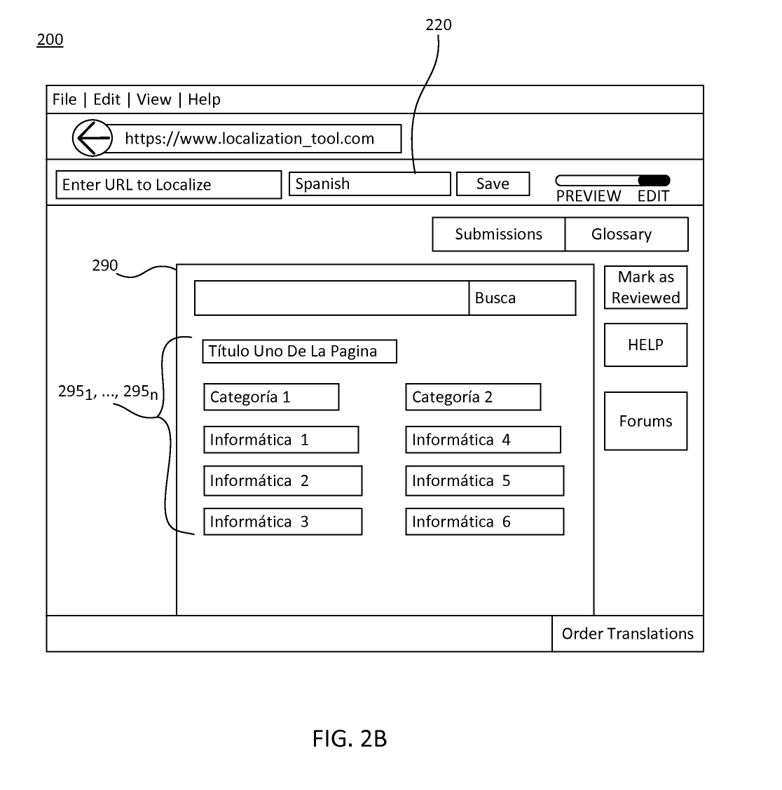

FIG. 2A illustrates an exemplary embodiment of a localization interface that allows a user to localize content. For example, a user may upload content to a localization interface 200 to view and/or edit content 250. Localization interface 200 includes a text input interface 210 which allows a user to enter a uniform resource locator (URL) that references the content to be localized. Once content 250 is received, it is shown within localization interface 200. Here, content 250 includes a web page comprising elements 260₁, . . . , 260ₙ (collectively “260”). The elements 260 may include headings, strings, images, audio, video, widgets, etc. It should be appreciated that some elements may be designated such that they are not localized, such as a variable. In some embodiments, portions of content may be associated with data such that the portions are not translated, or not shown at all. For example, a company's blog may not be localized. In various embodiments, the entire appearance of a page may be modified by a user via a localization management system. Other content may be marked such that it is no localized. For instance, dates, usernames, or page numbers may be designated such that they are not localized. In some embodiments, a user (e.g., an administrator) may use the localization system 120 to modify all, or a portion of, the content and the appearance of a webpage (mobile or otherwise).

Localization interface 200 may also include a language selection widget 220 that allows a user to select a language for localization. After selecting a language, the localization interface 200 displays the localized version of the webpage. In some embodiments, if the web elements have yet to be translated, a user may manipulate an order translation widget 280 (e.g., a button that allows a user to order a translation of the content using a translation management system 140). In some embodiments, a user may use a keyboard to navigate through elements 260 and edit them as the user sees fit.

In some embodiments, when the content 250 is localized, the user may select one of two modes: preview or edit. In some embodiments the edit mode is selected by default. This may be performed using widget 240. For example, in preview mode, a user may view a localized version of their content (or elements thereof), and in edit mode, a user may edit the localized content (or elements thereof). Since a content creator may be particularly conscious of their work, they may disagree with how the content was localized by the translation management system 140, and further modify the content as desired.

In some embodiments, localization interface 200 also includes widgets such as a suggestions tab or button 265, a glossary tab 266, a mark as reviewed button 267, a help button 270, and/or a forums button 275. For example, a suggestions tab 265 allows a user to view possible ways in which content 250 may be localized. In some embodiments, a user is presented with a plurality of potential localized versions of the content, and the user may select one of the potential localized versions. Translations may be contributed by past user(s) and suggested to a user as a potential localized version. In response to selecting a suggested version, the suggested version is used as the respective localized version. In addition, a glossary tab 266 may be selected to show versions of localized content where particular words are highlighted and translated in the same way. A mark as reviewed button allows a user to approve content 250. A help button 270 may allow a user to communicate with a translator, or a technician to assist the user with localizing the content 250. As another example, the forums button 275 may cause the user to be sent to forums associated with localizing content and/or forums associated with the operation of the localization interface 200. Once a suitable localization is created, a user may click a save button 230 in order to save the localized version of the content 250, and/or approve the localized elements of the content 250 for delivery. For example, once a suitable version of content elements in a second language is approved, a localization file may be created and sent to a content delivery network 150 where it may be accessed by client devices 110.

Although the exemplary embodiment of a localization interface may be presented to a user on desktop or laptop computer, it should be understood that embodiments described herein may be implemented on a mobile device. For example, the localization management system may be controlled by a user with a smart phone. In some embodiments, the user interface 200, or a portion thereof may appear differently based on the device it is displayed on. For example, embodiments of a localization management system on a mobile phone may not have a user interface which allows a user to directly modify a layout and/or content. In some embodiments, every feature of the localization interface 200 is present on a mobile version of the localization interface. Thus, embodiments described herein and shown in FIGS. 2A and 2B should be construed merely as examples.

FIG. 2B also illustrates an exemplary embodiment of a localization interface 200 that allows a user to localize content 250. As shown in localization interface 200, the language selection widget is used to select Spanish. As a result, the Spanish version of the content 250 including content elements 295₁, . . . , 295ₙ (collectively “295”) is shown. For example, the string “Heading 1” may be replaced with “Thulo Uno De La Pagina.”

In some embodiments, the translated version may not fit within the space provided by a content or web element. For example, while “Heading 1” may fit within a hyper-text markup language (HTML) table with a predetermined size, “Thulo Uno De La Pagina” may not fit within the HTML table. To remedy this, a user may change the size of the table on a particular localized version of the content 290 within the localization interface 200. Once the size of the table is changed, the user may approve the localized elements and create a localization file for publication. Allowing an automatic or a manual translation management system 140 to translate a page may cause an undesirable look and feel of content when it does not fit within a predefined space. It should be appreciated that in some embodiments the localization of content is not one-on-one and requires more complex manipulation. For example, with genders and plurals in various languages (e.g., English has 2 plural rules while Arabic has 6 plural rules).

Similarly, as shown in localization interface 200, a button may be replaced with localized text. For example, FIG. 2A shows that the “Search” button was replaced with a button that reads “Busca.” A button may include editable text, or it may be an image. In either case, a translation management system 140 is capable of localizing a button, image, element, or other type of widget based on a preferred language and/or locale.

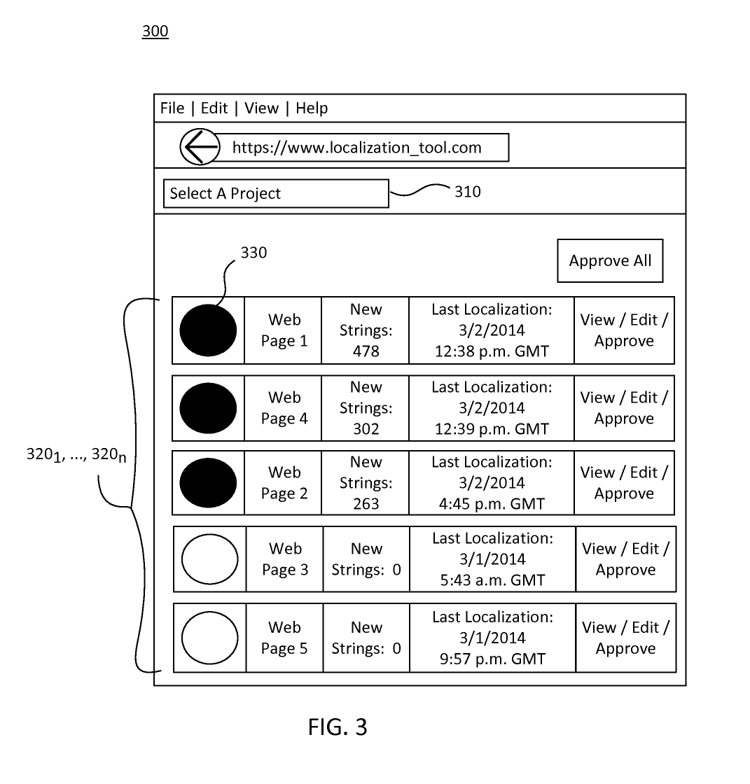

FIG. 3 illustrates an exemplary embodiment of a user interface 300 to manage localization. It should be understood that user interface 300 is only an example, and that the functions capable of being performed by 300 may be implemented by a variety of different user interfaces. As discussed above, user interface 300 may contain the same functionality whether it is displayed on a mobile device or on a personal desktop or laptop computer. Unless otherwise specified, the various embodiments described herein are not intended to limit the scope of the invention to a particular type of electronic device.

Example user interface 300 allows a user to select a project 310 (e.g., content) and determine whether changes have been made to the content. User interface 300 may allow a user to view various portions of content 320₁, . . . , 320ₙ (collectively “320”) and create localization files accordingly. Portions of content 320 may include, but are not limited to: a webpage, an entire website, elements of a web page, an application, a mobile application, a portion of a mobile application, etc.

In some embodiments, an icon 330, or some other type of notification is provided which indicates that a particular portion of content 320 has been generated. Such as a new review in a review website, or a new comment on the comment board of a news website. In example user interface 300, an icon with a darkened circle indicates that a respective element of content has been generated, while an icon that has not been filled indicates that the respective element of content has not been generated. In some embodiments, the example user interface 300 may indicate what elements of content have been generated (e.g., a number of strings and/or their location), and when the strings were generated. In such an example, a localization system may perform various operations. For example, a localization system may refrain from localizing the generated content until it is approved by a user, for instance, by clicking on an approve button. In some embodiments, a user may be sent to user interface 200 by clicking on a view and/or edit button. In some embodiments, a user may simply click a button to approve all generated content that was automatically localized.

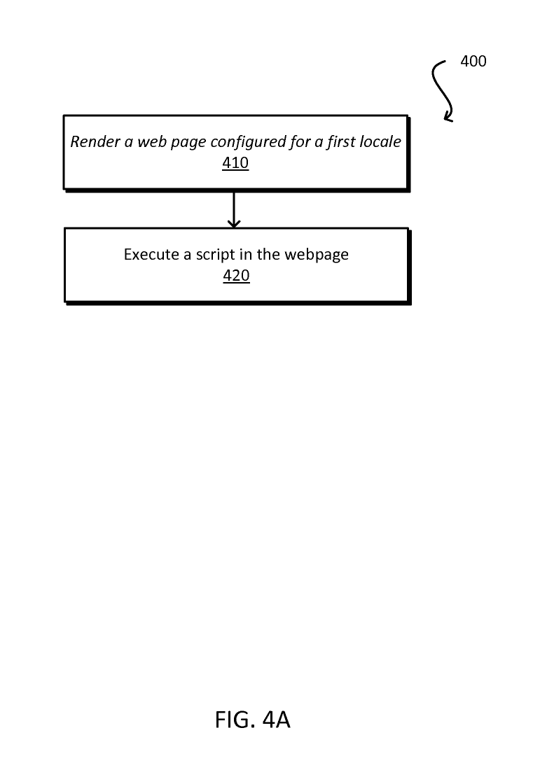

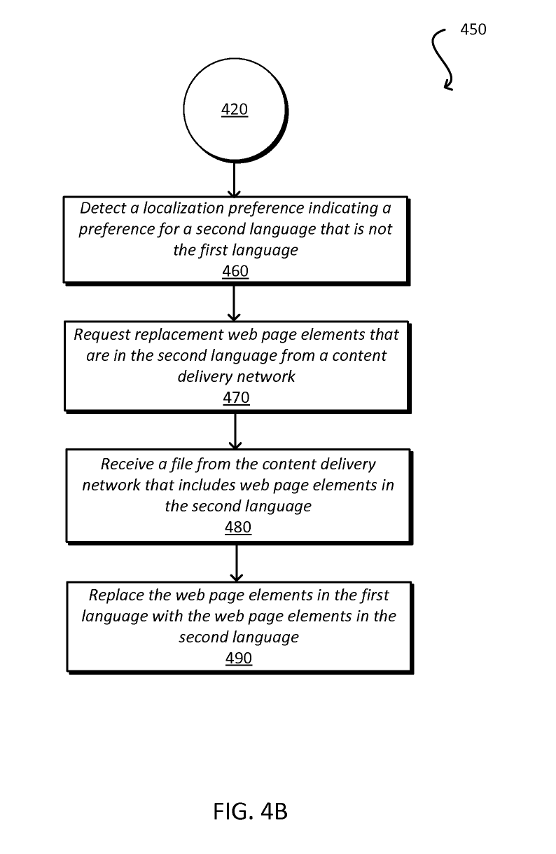

FIG. 4A, and FIG. 4B illustrate an exemplary method embodiment for localization. It should be understood that example method embodiments are shown for example only. Additional or fewer steps may be added or removed from the method embodiments shown herein. In addition, at least portions of the described method diagrams shown in FIGS. 4A and 4B may be performed in a different order, in parallel, or not performed at all.

As shown, the method 400 begins at block 410, where a web page is rendered for a first locale. Although a web page is used as an example, the methods and systems described herein may apply to content other than web pages, such as applications, portions of applications, images, videos, etc. The web page may have been requested by a client device or application that is associated with a first locale. For example, the client device may include a browser that is configured to request content corresponding to a particular language or location. The web page may contain elements in a first language. Upon rendering the web page, a script is executed 420 in the webpage performs steps as shown in FIG. 4B. For example, a client device may request a web page from a URL that includes an embedded script. The embedded script then causes a browser on a client device to perform the steps shown in method 450.

FIG. 4B illustrates an exemplary method embodiment for localizing content. Method 450 begins when a script is executed 420 on a client device. As shown at block 460, the executing script includes instructions which cause a processor to detect a localization preference indicating a preference for a second language that is not the first language. For example, to determine the second language, the script may access information associated with: an application, an operating system, a particular domain (e.g., fr.example.com), the selection of a language by selecting an element on a web page (e.g., a drop-down menu), etc. Upon determining the second language, at block 470, the script may request replacement web page elements that are in the second language from a content delivery network. For example, a client device may contact content delivery network 140 to request a localization file that includes elements of the web page in a different language. At block 480, a localization file from the content delivery network is received. The file includes web page elements in the second language. As addressed above, in addition to merely containing translated text, the received localization file may include translated widgets, a different layout (as opposed to the web page corresponding to the first language), a re-styling of a web page (mobile or otherwise), etc. For example, a localized web page may include a layout based at least in part on a language or location and the original web page.

At block 490, the web page elements in the first language are replaced with web page elements in the second language. For example, the received localization file may include elements in the second language. In some embodiments, this process is performed in such a manner that the client device that requested the localized web page never renders the original web page with the elements in the original language.

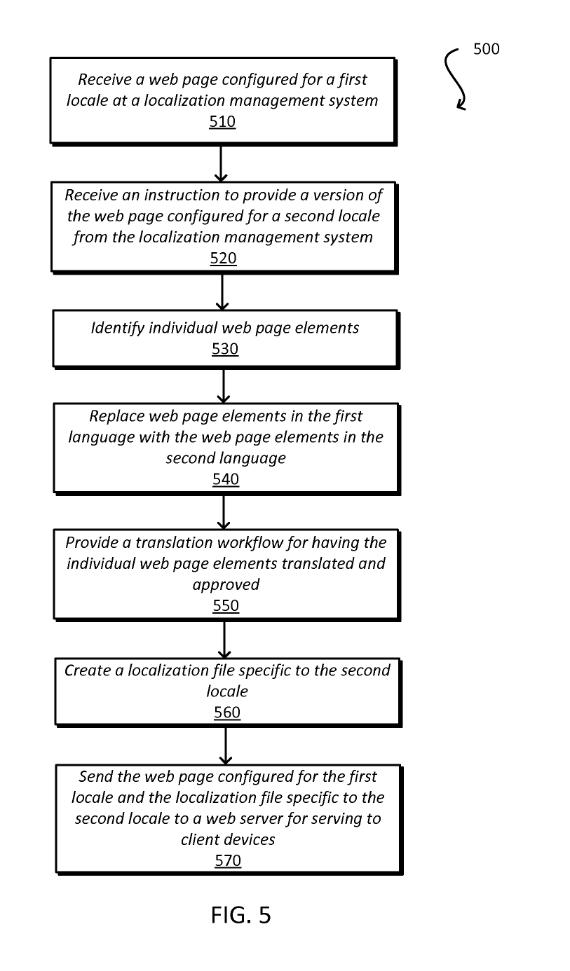

FIG. 5 illustrates an exemplary method embodiment for localization. It should be understood that example method embodiments are shown for example only. Additional or fewer steps may be added or removed from the method embodiments shown herein. In addition, at least portions of the described method diagram shown in FIG. 5 may be performed in a different order, in parallel, or not performed at all.

At block 510 of method diagram 500, a web page configured for a first localization preference is received at a localization management system. For example, a user that desires to place content online that is capable of being localized may send that content to a localization management system. A script may be embedded in this content which may cause users that request the content to receive a localized version of the content. Upon receiving the web page, at block 520, the localization management system receives an instruction to provide a version of the web page configured for a second locale. For example, the instruction may cause elements of the web page to be sent to a translation management system to be localized.

As shown in block 530, in some embodiments, individual web page elements are identified. For example, the localization system may parse content to determine whether all or a portion of a web page is capable of being localized. In some embodiments, content may contain variables or other content that is designated such that it is not translated and/or localized. For instance, a user may be able to classify a portion of content, an element of a web page, or a portion of a script such that it displays on a client device in the same manner regardless of any performed localization. At block 540, web page elements (or at least a portion thereof) in the first language are replaced with web page elements in the second language. In some embodiments, this replacement may be performed by at the localization system, and a localization file may be created and approved.

As will be appreciated by one skilled in the art, at least a portion of a translation management system may be included in a localization system. A browser may detect, collect, and send strings added to a website by an end-user to a translation management service, and store them in a data store (e.g., a queue, a temporary location). As discussed herein, the strings added by an end-user may are stored in a localization management system (or a translation management system, which may be included in the localization management system). Localization files may be updated, and the localization file(s) may be sent to the content delivery network once it is approved (e.g., they may be re-published using the same content delivery network. At block 550, a translation workflow is provided for having the individual web page elements translated and approved. A translation workflow may include the steps required to localize elements. In addition, a translation workflow provides a user with the ability to approve localized content before it is available to a third party requesting the localized content. This approval may be performed automatically, manually, or in any combination thereof. At block 560, a localization file specific to the second locale is created. For example, the localization file may cause web elements to be replaced in response to a client device executing a script embedded in the web page configured for the first locale, as described in block 510. At block 570, the web page configured for the first locale and the localization file specific to the second locale are sent to a web server for serving to client devices. In some embodiments, this file is distributed to a content delivery network, which may include multiple servers in multiple locations. In some embodiments, in response to a user requesting a localized version of a web page for which there is no localization file, a notification may be created by the localization management system indicating that additional localization files have been requested.

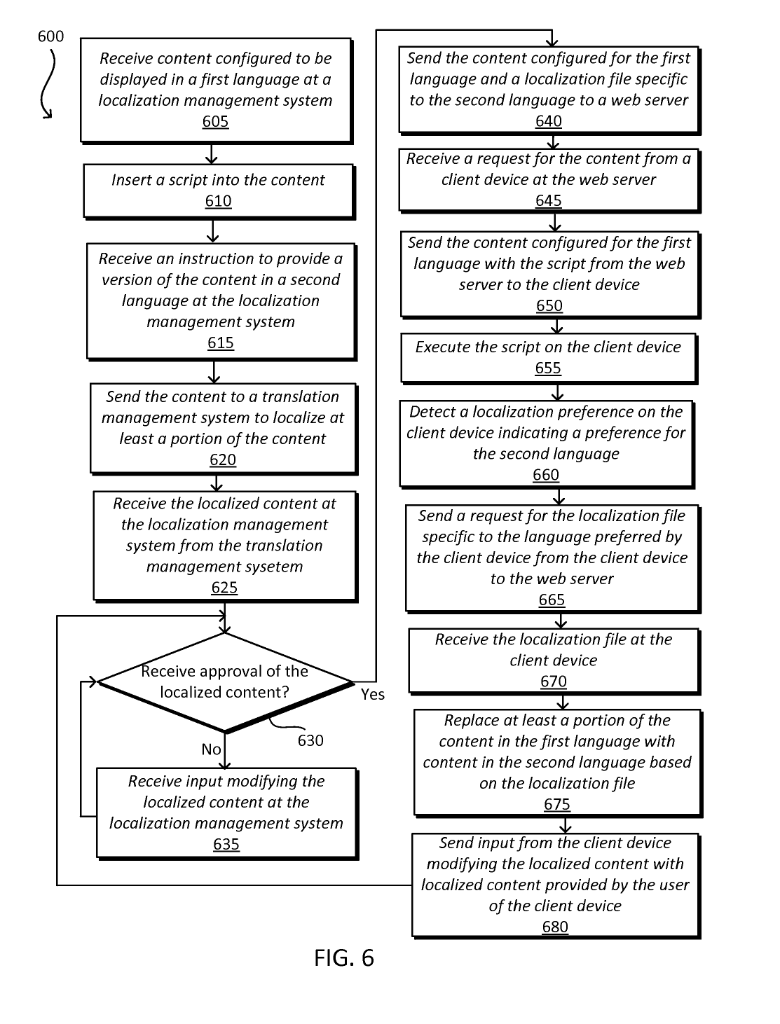

FIG. 6 illustrates an exemplary method embodiment for localization. It should be understood that example method embodiments are shown for example only. Additional or fewer steps may be added or removed from the method embodiments shown herein. At least portions of the described method diagram shown in FIG. 6 may be performed in a different order, in parallel, or not performed at all. Further, as will be addressed below, some of the steps performed in method 600 may be performed by one or more of the devices described herein.

At block 605, content configured to be displayed in a first language is received at a localization management system. For example, a content owner may upload their content to a localization management system to allow users to receive localized versions of their content. Of course, in some embodiments, a content owner may receive a script and insert it into the content configured to be displayed in a first language without requiring an owner to upload their content. At block 610, a script is inserted into the content by the localization management system or a content owner. For example, a localization system may create a script for a content owner to place in their content. In some embodiments, a localization system may directly modify the content to include the script. In some embodiments, the localization management system is configured to generate code for a user to place into their content, the code causing a script to execute, the script causing various functions to be performed as discussed herein. It should be understood that these are merely examples, and in some embodiments various blocks may occur in a different order, or not at all. For instance, a script may be embedded into the content prior to the content being received by a localization management system.

At block 615, an instruction to provide a version of the content in a second language is received at the system localization management system. This instruction may be provided using a drop-down menu. In some embodiments, this request is received from a content owner. For example, the content owner may instruct a translation management system to create versions of the content in Greek, Spanish, Chinese, Japanese, and French. As discussed herein, the language may also be determined without user input. At block 620, the localization management system sends the content (or elements thereof) to a translation management system to localize at least a portion of the content. For example, the translation management system may create localized versions of the content (e.g., web page elements, web pages, scripts, text, audio files, video files, images, and hyper-links).

At block 625, localized content is received at the localization management system from the translation management system. As briefly discussed above, the translation system has the functionality to translate languages, however the translation system may not have the functionality of the localization system (e.g., allowing user approval of localized content, distribution to a content delivery network, the creation of localization files, etc.). In examples described herein, the Greek, Spanish, Chinese, Japanese, and French versions of the content (or a portion thereof), may be received at the localization management system. In some embodiments, the localization management system may automatically create language specific localization files corresponding to each received version of the content, or a portion thereof. For example, only a portion of content may be localized based on an amount of resources required to localize some or all of the content. For example, only some images may be localized, etc. In some embodiments, the localization management system requires approval prior to creating localization files. For example, a content owner using the localization management system may be allowed to review and/or edit the localized content (e.g., localization files, localized web page elements, localized scripts, localized hyper-links). In some embodiments, this process is used to ensure that the localized content displays on a user device in accordance with the content owner's desires. Such an application may be referred to as a content management system. For example, the localization management system may be configured to receive input via a “what you see is what you get” (WYSIWYG) editor. This received input may modify portions of content including, but not limited to: HTML code, hyper-links, text, text spacing, variables, scripts, web page elements, files including closed captioning, audio files, and video files. In some embodiments, a translation management system may be configured to allow a user to view and/or edit content on multiple devices such as a personal computer, a smart phone, a tablet, a wearable computer, a particular browser, etc. Further, in some embodiments, multiple localization files may be created that correspond to a particular piece of content and a particular language. For example, a localization file may correspond to a particular web page to be displayed in French on a tablet computer.

At block 630, a determination is made as to whether approval of the localized content was received at the translation management system. For example, a user may approve a localization file received from a translation management system. In some embodiments, as will be discussed below, a user (e.g., an administrator) may approve content received from a client device (e.g., an end user). If approval of the localized content is not received, at block 635, input modifying the localized content is received at the localization management system. For example, if a content owner provides input to the localization management system that the received localized content (whether from a translation management system, a user, or elsewhere) is rejected, the content owner may be prompted to modify the localized content. It should be noted that this step is optional, and that in some embodiments, if the received localized content (or received input modifying the localized content) is rejected, the method diagram 600 stops here.

In response to receiving approval of localized content (or input modifying localized content), at block 640 the content configured for the first language and a localization file specific to the second language are sent to a web server from the localization management system. In some embodiments, the web server is a content delivery network, and may comprise multiple servers.

At block 645, a request for the content is sent from a client device. The client device may request information at a particular URL, which may contain the content in the first language. In some embodiments, the content in the first language is hosted on a server other than the localization system. For example, the content in the first language may be hosted on the content delivery network. Upon receiving a request for content, the content configured for the first language is sent from the web server (e.g., the content delivery system) to the client device. In some embodiments, a web server may collect information on the request. Such information may include what phrases were suggested, the time of the request, the location of the request, etc. The localization management system may store this information to create analytics. As described herein, the content configured for the first language may be a web page with an embedded script. At block 655 the script is executed on the client device. The script may cause the client device to perform multiple actions, including determining language preferences associated with the device, requesting localization files, replacing portions of content based on information within a localization file, etc. At block 660, a localization preference is detected on the client device indicating a preference for the second language. For example, the script may determine that an application or an operating system is set to provide information in a language other than the first language of the content. It should be appreciated that a client device may be associated with more than one language. For example, a client device may be associated with Spanish, English, and Italian. At block 665 a request is sent to the web server for the localization file specific to the language preferred by the client device. Continuing with the example above, if multiple languages are associated with a client device, a request may include a “fall-back” language, or a third language. In some embodiments, if a localization file corresponding to a second language is not available on a web server, but a localization file corresponding to a third language is available, a web server may deliver a localization file in the third language (hence, why it may be referred to as a “fall-back” language). In some embodiments, if requested localization content corresponding to a particular language is requested by a client device, and that requested localization content is not available, a notification may be generated by the localization management system. For example, the localization management system may notify a web server that the requested localization file is not available. This notification may indicate the requested language and content. Thus, a content owner may submit the content to a translation management system and create a localization file based on the notification. In some embodiments, a localization system may receive a notification indicating that a requested localization file corresponding to a particular language was not available on the content delivery network, and then automatically create a localization file corresponding to the content and the indicated particular language. For example, a localization management system may automatically send the content to a translation management system with a request to localize the content, and automatically create a localization file and send that localization file to a web server for delivery to the client that sent the request. In some embodiments, a localization file may be generated, but will not be sent to the web server until approval is received, as described above.

At block 670, a localization file is received at the client device. In some embodiments. At block 675, replaces at least a portion of content in the first language with content in the second language based on information included in the localization file specific to the second language. For example, the script may extract data from the localization file specific to the second language and replace content in the first language based at least in part on the data from the localization file.

At block 680, the client device sends input modifying the localized content with localized content provided by the user of the client device. It should be appreciated that sending input modifying localized content may be performed in a number of methods. For example, a client device may receive localized content that includes a message board. In such a case, the client device may add its own localized content to the message board. In turn, the added localized content may be sent to the localization management system. At block 630, a localized content management system awaits approval of the additional localized content sent from the client device. As described above, if the localization management system receives input indicating that the localized content received from the client device is approved, then a new localization file specific to the particular language is created and sent to a web server as in block 640. As with other embodiments described herein, the localization file is modified to reflect changes made by an end user and approved by a content owner, and the original content remains unchanged.

As another example, a client device may receive input indicating that the localization is not correct. The client device may then send this information to the localization management system. As described with respect to user interface 300, a content owner may approve changes to the localized content suggested by a user (e.g., modified content received from a client device).

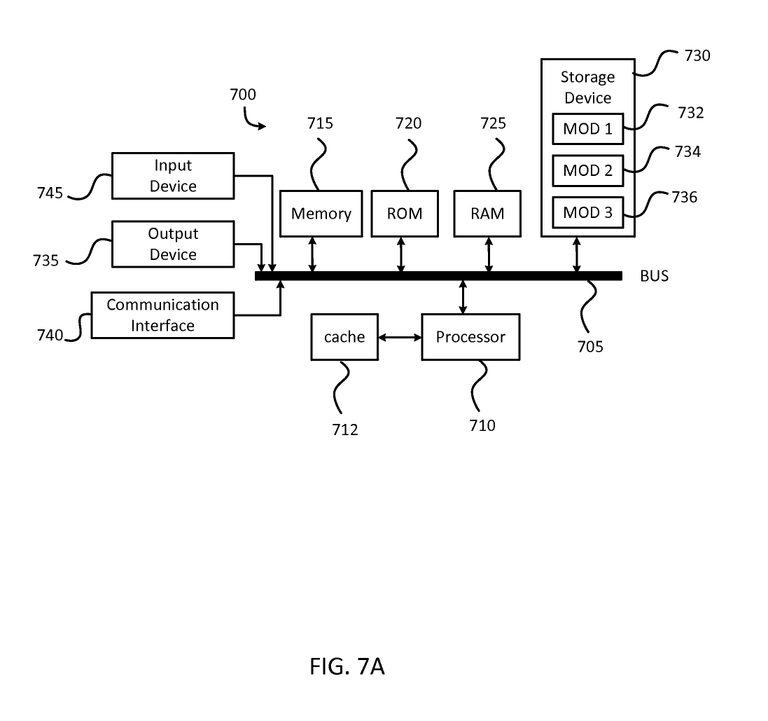

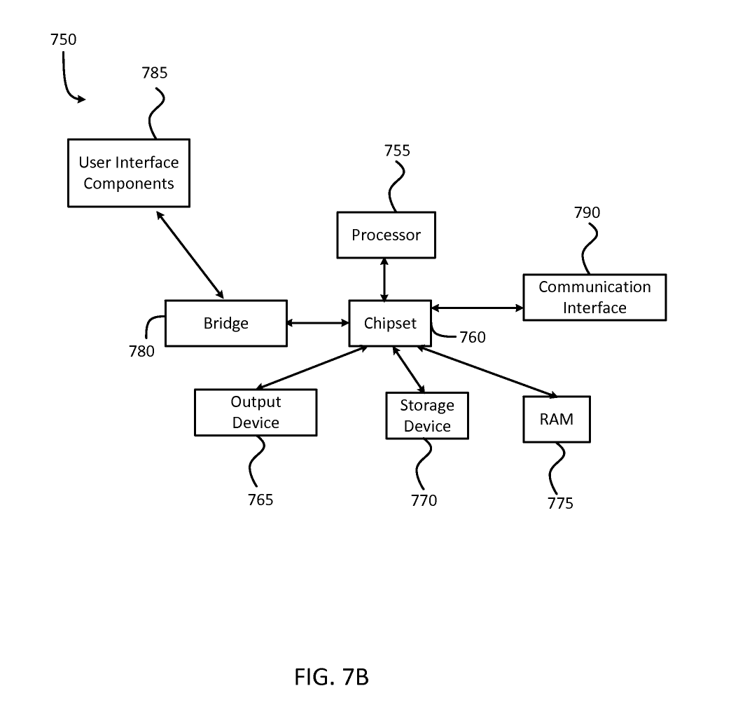

FIG. 7A, and FIG. 7B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1-4. (canceled)

5. A computer-implemented method comprising:
accessing, by a localization management system, a web page configured for a first locale, the web page including individual web page elements in a first language, and a script;
receiving, by the localization management system, an instruction to provide a version of the web page configured for a second locale including web page elements in a second language;
identifying the individual web page elements in the first language;
providing a translation workflow for:
having the individual web page elements in the first language translated into the individual web page elements in the second language; and
having the individual web page elements in the second language approved;
creating a localization file for the second locale including the individual web page elements in the second language, wherein the localization file is configured to be accessed by the script to replace the web page elements in the first language with the web page elements in the second language; and
sending the localization file specific to the second locale to a web server for serving to client devices.

6. (canceled)

7. The computer-implemented method of claim 5, wherein having the individual web page elements in the first language translated into the individual web page elements in the second language further comprises:
sending the individual web page elements in the first language to the localization management system; and
receiving the individual web page elements in the second language from the localization management system.

8. The computer-implemented method of claim 5, further comprising:
providing a version of the content web page elements configured for the second locale for display.

9. The computer-implemented method of claim 8, further comprising:
modifying one or more of the individual web page elements in the second language.

10. (canceled)

11. The computer-implemented method of claim 9, further comprising:
receiving input from a user causing the one or more of the individual web page elements in the second language to be modified.

12. The computer-implemented method of claim 8, further comprising:
prompting a user for approval of one or more of the web page elements in the second language; and
receiving approval of the one or more of the web page elements in the second language.

13. The computer-implemented method of claim 5, further comprising:
receiving a request to modify of at least one web page element in the second language.

14. The computer-implemented method of claim 13, further comprising:
prompting a user for approval of the request to modify; and
in response to receiving approval of the request to modify:
creating a modified localization file specific to the second locale; and
sending the web page configured for the first locale and the modified localization file specific to the second locale to the web server for serving to client devices.

15. A system for managing and distributing a localized web page comprising:
a localization management system configured to:
receive web page elements configured for a first locale, the web page elements configured for the first locale being from a web page containing a script that identifies the web page elements configured for the first locale;
receive an instruction to provide a version of the web page configured for a second locale including web page elements in a second language;
create a localization file specific to the second locale, the localization file including web page elements in the second language, wherein the localization file is configured to be accessed by a script to replace the web page elements in the first language with the web page elements in the second language; and
send the web page configured for the first locale and the localization file specific to the second locale to a web server for serving to client devices; and
a client device executing a browser configured to:
execute the script in the webpage wherein the script is configured to:
detect a localization preference indicating a preference for the second language;
request from a web server the localization file specific to the second locale; and
replace the web page elements in the first language with the web page elements in the second language from the localization file, without the web page elements in the first language being displayed.

16. The system of claim 15, wherein the localization management system is further configured to:
prompt a user for approval of the localization file specific to the second locale; and
receive approval of the localization file specific to the second locale.

17. The system of claim 15, wherein the localization management system is further configured to:
provide an interface to allow a user to modify the localization file specific to the second locale.

18. The system of claim 15, wherein the script is further configured to:
provide an interface to allow a user to modify the web page elements in the second language; and
send the modified web page elements in the second language to the localization management system.

19. The system of claim 18, where in the localization management system is further configured to:
receive modified web page elements in the second language.

20. The system of claim 19, wherein the localization management system is further configured to:
prompt a user for approval of modified web page elements in the second language received from the client device;
receive approval of the modified web page elements in the second language;
create a modified localization file specific to the second locale; and
send the web page configured for the first locale and the modified localization file specific to the second locale to the web server for serving to client devices

21. The method of claim 5, wherein the web page further includes designated web page elements and wherein the designated web page elements are not translated and are not included in the localization file.

22. (canceled)

23. The method of claim 5, wherein the individual web page elements are received from a script configured to:
identify at least one web page element in a web page configured for a first locale; and
send the web page element to a localization management system to create a version of the web page element configured for the second locale.
